(19) United States
(12) Patent Application Publication
(10) Pub. No.: US 2007/0072155 A1
(43) Pub. Date: Mar. 29, 2007

(54) Method for improving language learning in a mobile phone

(75) Inventors: Cheng-Shing Lai, Taipei (TW); Hong-Liang Liu, Nanking (CN); Xiao-Long Fan, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/518,214

(22) Filed: Sep. 11, 2006

(30) Foreign Application Priority Data
Sep. 12, 2005 (TW) 094131258

(51) Int. Cl. G09B 5/00

(52) U.S. Cl. 434/169

(57) ABSTRACT

The present invention discloses a method for improving language learning in a mobile phone having an execution program, a database and a player, where the database includes a plurality of language learning contents, and the execution program retrieves a language learning content from the database after the mobile phone is turned on, and the retrieved language learning contents substitute various hint tones of the mobile phone, and the player plays the retrieved language learning contents, such that the mobile phone can play the language learning contents as hint tones repeatedly, so as to improve the language learning effect.

### FIELD OF THE INVENTION

The present invention relates to a method for improving language learning in a mobile phone, and more particularly to a method that uses a mobile phone to play a language learning content as a hint tone repeatedly.

### BACKGROUND OF THE INVENTION

As the information science and technology advance and the electronic industry blooms, various high-tech products derived from computers and mobile communications are developed rapidly, and these products are indispensable to our life and can shorten the time and space between people. At present, mobile phones (also known as cellular phones) and personal digital assistants (PDA) become very popular and have a high utility rate, and thus the competition of the market becomes increasingly severer, and major manufacturers constantly introduce innovative products with different functions and features to attract consumers, and users expect that electronic communication products can integrate more functions and other related devices of different specifications (such as MP3 and language translator, etc), and thus providing more convenient and effective services in the foregoing communication products become an important index for the manufacturing capability of the high-tech products in different countries.

In recent years, a mobile phone usually integrates a language translator to provide a mobile phone with the language learning and communication functions, in hope of effectively gaining the market share in the student and language learner segment as well as satisfying consumers' language learning requirements for instantly inquiring a single word or its derived phrases. Manufacturers have developed various different kinds of mobile phones for learning English and/or Japanese language, such as when a user simply enters a new word in English or Japanese into the mobile phone, the mobile phone will show the explanation and usage of the new word and play the pronunciation of the new word based on a translated word database and a voice database corresponding to the new word by means of a built-in translation database and a built-in voice database.

However, there is no shortcut for learning a language, and the one and only one way for learning a language well is to memorize and use the language repeatedly everyday, wherein an important course for learning a language is to correct a user's pronunciation, and learners should listen to the pronunciation of such language as well as improving their listening comprehension ability. However, the traditional language translator of a mobile phone is fixed to a certain aspect for the language learning, and thus the learners cannot improve their language proficiency if they cannot use the language translator frequently, or lack of the motive of using the language translator to improve the effectiveness. Even there are plenty of vocabularies in a translated word database of the language translator and detailed explanation on their usage, the learners still cannot make much progress.

Therefore, finding a method for improving language learning in a mobile phone, such that the mobile phone unceasingly plays the vocabulary or the phrase content for a language learning process daily to deepen the user's memory and impression about a vocabulary or a phrase content of the language and converts a short-term memory into a long-term memory to achieve the expected learning effect is an important subject for electronic communication designers and manufacturers.

### SUMMARY OF THE INVENTION

In view of the foregoing shortcomings of the prior art, the inventor of the present invention based on years of experience to conduct extensive researches and experiments and finally invented a method for improving language learning in a mobile phone.

Therefore, it is a primary objective of the present invention to overcome the foregoing shortcomings by providing a method for improving language learning in a mobile phone that installs an execution program, a database and a player in a mobile phone. The database includes a plurality of language learning contents, and the execution program retrieves a language learning content from the database after the mobile phone is turned on, and the retrieved language learning content replaces various hint tones of the mobile phone and the player plays the retrieved language learning content, such that the mobile phone plays the language learning content frequently and repeatedly as a hint tone in our busy daily life, so as to improve the language learning effect.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic view of the structure of the invention;

FIG. 2 is a schematic view of a preferred embodiment of the invention;

FIG. 3 is a flow chart of a preferred embodiment of the invention;

FIG. 4 is a flow chart of a preferred embodiment of the invention;

FIG. 5 is a flow chart of a preferred embodiment of the invention; and

FIG. 6 is a flow chart of a preferred embodiment of the present invention.

### DETAILED DESCRIPTION OF THE PREFERRED EMBODIMENTS

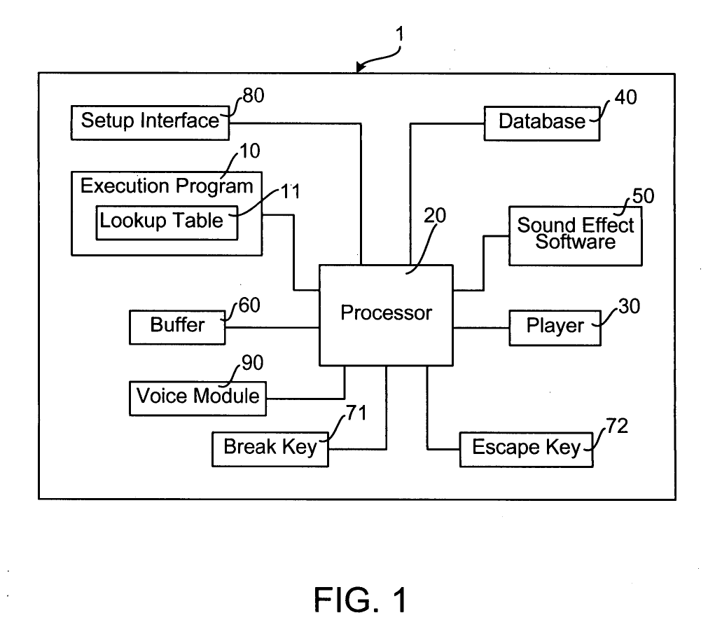

Referring to FIG. 1 for a method for improving language learning in a mobile phone, the mobile phone 1 includes an execution program 10, a processor 20, a player 30 and a database 40 containing a plurality of language learning contents (such as words or complete sentences). After the mobile phone 1 starts the execution program 10, the processor 20 will search and retrieve a language learning content in the database 40 by the execution program 10, and the processor 20 replaces the hint tones of the mobile phone 1 by the retrieved language learning contents, such that the player 30 can play the retrieved language learning contents from the mobile phone 1 at the time when it is necessary to play a hint tone. Therefore, such arrangement can play the language learning contents frequently and repeatedly as the hint tones of the mobile phone 1 in our daily life, so as to improve the language learning effect.

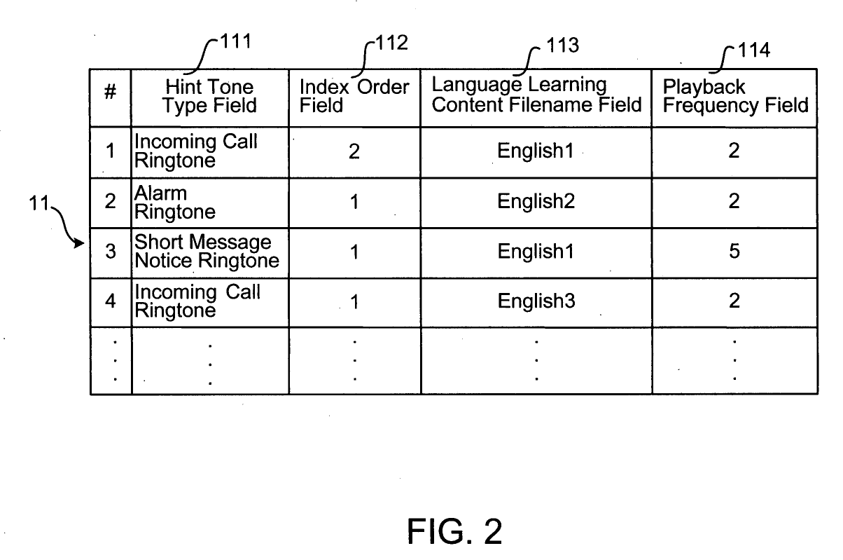

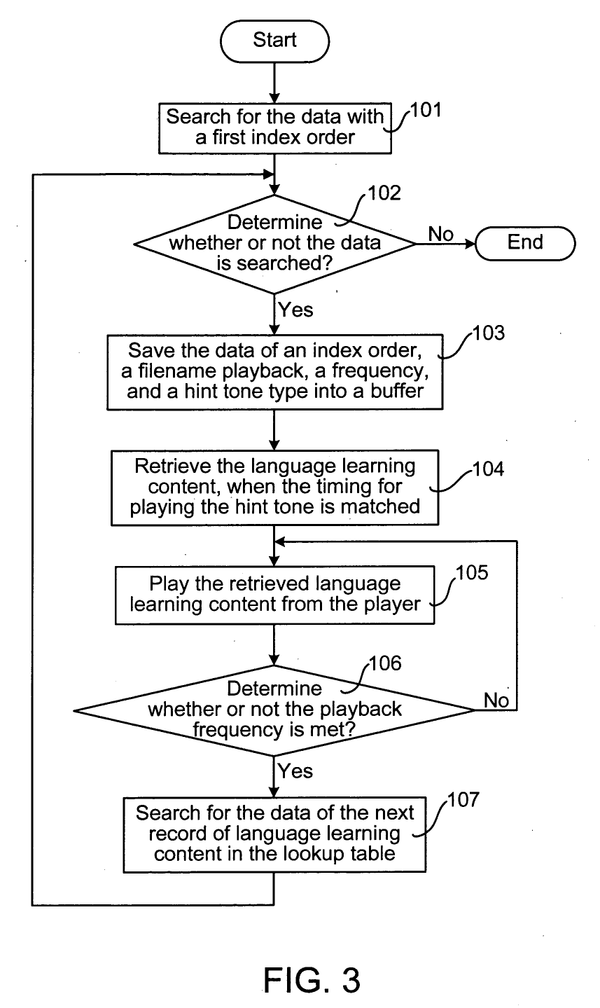

In FIGS. 1 and 2, the mobile phone 1 installs a sound effect software 50 for controlling the content and timing of playing a hint tone, and the execution program 10 has a lookup table 11 containing a plurality of fields, and the fields can be dividend into a hint tone type field 111, an index order field 112, a language learning content filename field (or audio filename) 113 and a playback frequency field 114, etc. The contents of the hint tone type field 111 (such as an incoming call ringtone, a short message notice ringtone or an alarm ringtone) are provided to the sound effect software 50 to determine that the mobile phone 1 plays a hint tone type of data, and the language learning content filename field 113 records a plurality of filenames, and each filename corresponds a language learning content, and the index order and playback frequency fields 112, 114 record an index order of playing the language learning content filename and a playback frequency of playing the language learning content respectively. If the execution program 10 is started by the mobile phone 1, the processor 20 will process the following steps as shown in FIG. 3:

Step 101: Look up the index order field 112 in the lookup table 11 to search for the data in a filename field 113, a playback frequency field 114, and a hint tone field 111 of a language learning content with a first index order;

Step 102: Determine whether or not the data is searched; if yes, then go to Step 103, or else end this procedure;

Step 103: Save the data with an index order, a filename playback, a frequency, and a hint tone type of a language learning content into a buffer 60 of the mobile phone 1;

Step 104: The sound effect software 50 retrieves the language learning content from the database 40 according to the data of hint tone type and language learning content filename saved in the buffer 60, if the timing for playing the hint tone is matched;

Step 105: Play the retrieved language learning content from the player 30;

Step 106: Determine whether or not the playback frequency is met based on the playback frequency saved in the buffer 60; if yes, then go to Step 107, or else return to Step 105; and

Step 107: Look up an index order field 112 in the buffer 60, and search for the data such as a filename, a playback frequency and a hint tone type of the next record of language learning content in the lookup table 11 (as shown in FIG. 2), and return to Step 102.

Therefore, the sound effect software 50 keeps playing all of the language learning contents in the lookup table 11 as the hint tones based on the playback frequency of the lookup table 11, until the playback of all language learning contents in the lookup table 11 is finished.

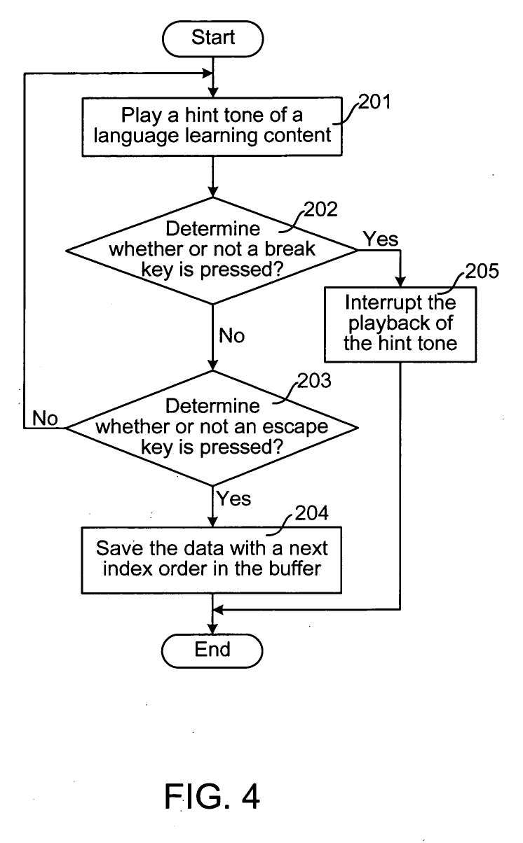

In the foregoing preferred embodiment as shown in FIG. 1, if the language learning content or playback frequency replaced for the hint tone (such as the music) of the mobile phone 1 is too long or inappropriate, the execution program 10 can be controlled by a break key 71 and an escape key 72 of the mobile phone 1, such that when the sound effect software 50 plays the hint tone of the language learning content as shown in FIG. 4, the processor 20 processes the following steps:

Step 201: The sound effect software 50 plays the hint tone of the language learning content;

Step 202: Determine whether or not the break key 71 is pressed; if yes, then go to Step 205, or else go to Step 203;

Step 203: Determine whether or not the escape key 72 is pressed; if yes, then go to Step 204, or else return to Step 201;

Step 204: Look up an index order field 112 in the lookup table 11, and find the data such as the language learning content filename, playback frequency and hint tone type for the next index order, and save the data into the buffer 60, and process the next step; and

Step 205: The sound effect software 50 interrupts the playback of the hint tone.

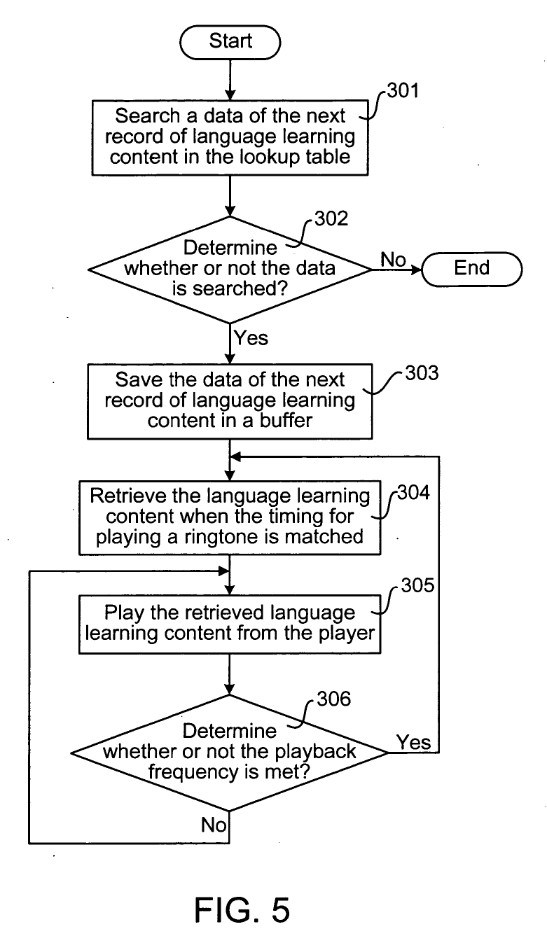

In the present invention, the processor 20 plays the language learning content for a next hint tone as shown in FIG. 5 and according to the following steps, after the hint tone is interrupted.

Step 301: Look up an index order field 112 in the buffer 60, and search for the data including the filename, playback frequency and hint tone type of the next record of language learning content in the lookup table 11;

Step 302: Determine whether or not the data is found; if yes, then go to Step 303, or else end this procedure.

Step 303: Save the data including the index order, filename, playback frequency and hint tone type of the next record of language learning content into the buffer 60;

Step 304: Retrieve the language learning content from the database 40 based on the data including the hint tone type and language learning content filename in the buffer 60, when the sound effect software 50 finds a match of the timing for playing the hint tone; and

Step 305: Play the retrieved language learning content from the player 30;

Step 306: Determine whether or not the playback frequency is met according to the playback frequency in the buffer 60; if yes, then go to Step 304, or else return to Step 305.

When the hint tone is played for the next time, the hint tone with the same language learning content will not be played from the beginning again, and the language learning content with a next index order in the lookup table 11 will be played as the hint tone, until the playback of all language learning contents in the lookup table 11 is finished or the playback is interrupted by the break key 71.

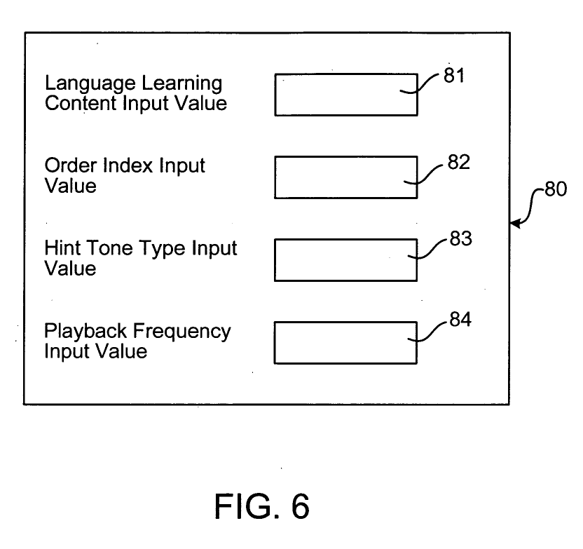

In the preferred embodiment as shown in FIGS. 1 and 6, the configuration of the execution program 10 can be set up by a setup interface of the mobile phone 1, and the setup interface 80 has a plurality of input values, and the input values includes a language learning content input value 81, an index order input value 82, a hint tone type input value 83, and a playback frequency input value 84. After the language learning content input value 81 is inputted to the mobile phone 1, the language learning content input value 81 is saved in the database 40. After the data with the index order input value 82, the hint tone type input value 83 and the playback frequency input value 84 are inputted, the data is inputted into the hint tone type field 111 of the lookup table 11 based on the hint tone type input value 83.

The mobile phone 1 further includes a voice module 90 for converting a character or a sentence in the language learning content to a pronunciation corresponding to the language. After the processor 20 retrieves a language learning content from the database 40, the voice module 90 converts the retrieved language learning content into a format (such as a MID format or a WAV format) playable by the sound effect software 50, and the sound effect software 50 plays the converted language learning content when the timing for playing a hint tone is matched. After the data with the language learning content input values 81 is inputted into the mobile phone 1, the voice module 90 converts the language learning content input value 81 into a format playable by the sound effect software 50, and saves all language learning contents into the database 40, such that the sound effect software 50 can immediately play the language learning content retrieved from the database 40. However, the voice module is a prior art, and the present invention simply mentions two of the feasible skills, and thus the traditional voice module will not be described in details here.

In FIG. 1, the ringtone of an incoming call of a mobile phone 1 in accordance with the present invention is set to play the language learning content of “Novelty (twice), Effectiveness (twice) and An Invention Needs to be Proved with Novelty and Effectiveness (Once)”. If the ringtone is rung and the ringtone of the incoming call of the mobile phone 1 is not interrupted by the break key 71, the mobile phone 1 will play “Novelty” twice, and then “Effectiveness” twice and finally “An Invention Needs to be Proved with Novelty and Effectiveness” once. However, if the ringtone of the incoming call is interrupted by the break key 71, the ringtone of the next incoming call will start playing from “Effectiveness”.

While the invention herein disclosed has been described by means of specific embodiments, numerous modifications and variations could be made thereto by those skilled in the art without departing from the scope and spirit of the invention set forth in the claims.

What is claimed is:

1. A method for improving language learning in a mobile phone, that is implemented to the mobile phone including a database having a plurality of language learning contents, comprising the steps of:
retrieving one of said language learning contents from said database;
substituting said language learning content as a hint tone; and
playing said language learning content when said mobile phone plays said hint tone.

2. The method as set forth in claim 1, wherein said mobile phone includes a sound effect software for controlling the content and timing for playing said hint tone.

3. The method as set forth in claim 1, wherein said mobile phone includes a execution program for retrieving the language learning contents includes a lookup table.

4. The method as set forth in claim 3, wherein said lookup table includes a hint tone type field and the content of said hint tone type field provides a data to said sound effect software to determine a hint tone type.

5. The method as set forth in claim 3, wherein said lookup table includes an index order field for recording the data of an index order for playing said language learning content filenames respectively.

6. The method as set forth in claim 3, wherein said lookup table includes a language learning content filename field for recording a plurality of filenames, and said filenames matches said language learning contents respectively.

7. The method as set forth in claim 3, wherein said lookup table includes a playback frequency field for recording a playback frequency for playing said language learning content respectively.

8. The method as set forth in claim 3, when said execution program is started, further comprising the steps of:
looking up said lookup table;
determining whether or not to search for the data about a language learning content, a filename playback, a frequency and a hint tone type;
if yes, then saving the data including an index order of said language learning content, said filename playback, said frequency, and said hint tone type into a buffer of said mobile phone;
retrieving said language learning content from said database based on the data of said hint tone type and said language learning content filename in said buffer, when the timing for said sound effect software to play said hint tone is matched;
playing said retrieved language learning content;
determining whether or not said playback frequency is met based on said playback frequency in said buffer;
if yes, then looking up said index order field in said buffer, and searching for a data of a filename, a playback frequency and a hint tone type of a next record of said language learning contents in said lookup table, and then determining whether or not said data of said next record of said language learning contents is searched.

9. The method as set forth in claim 8, further comprising the step of ending the procedure if no data about said language learning content, said filename playback, said frequency and said hint tone type is found.

10. The method as set forth in claim 8, further comprising the step of continuing playing said retrieved language learning content by said sound effect software, if determining that said playback frequency is not met based on said playback frequency in said buffer.

11. The method as set forth in claim 8, wherein said execution program is controlled by a break key of said mobile phone for interrupting the playback of said hint tone of said mobile phone and an escape key of said mobile phone for jumping to the playback of a next language learning content filename, such that when said sound effect software plays said hint tone of said language learning content, further comprising the steps of:
playing said hint tone of said language learning content by said sound effect software;
determining whether or not said break key is pressed;
if no, then determining whether or not said escape key is pressed;
if yes, then looking up lookup table, and finding the data with a next index order of said language learning content filename, said playback frequency and said hint tone type, and saving said data with said next index order in said buffer.

12. The method as set forth in claim 11, after said hint tone is interrupted, further comprising the steps of:
looking up said index order in said buffer, and searching for the data including a filename, a playback frequency and a hint tone type of said next record of said language learning contents in said lookup table;
determining whether or not the data of said filename, said playback frequency and said hint tone type of said next record of said language learning contents are found;
if yes, saving the data of said filename, said playback frequency and said hint tone type of said next record of said language learning contents into said buffer;
retrieving said next record of said language learning contents from said database according to the data of said filename, said playback frequency and said hint tone type of said next record of said language learning contents in said buffer, when the timing for said sound effect software to play said hint tone is matched;
playing said retrieved next record of said language learning contents;
determining whether or not said playback frequency of said next record of said language learning contents is met according to said playback frequency in said buffer; and
if yes, then retrieving said next record of said language learning contents from said database according to said language learning content filename in said buffer.

13. The method as set forth in claim 11, wherein said execution program has a configuration that can be set up by a setup interface of said mobile phone, and said setup interface has a plurality of input values, and said input values include a language learning content input value, an index order input value, a hint tone type input value and a playback frequency input value, said language learning content input value is inputted and saved in said database, and said index order input value, said hint tone type input value, and said playback frequency input value are inputted into corresponding said hint tone type field in said lookup table according to said hint tone type.

14. The method as set forth in claim 2, wherein said mobile phone further comprises a voice module for converting a character or a sentence in said language learning content into a pronunciation, such that after retrieving said language learning content from said database, further comprising the steps of:
converting said retrieved language learning content by said voice module into a format playable to said sound effect software; and
playing said language learning content by said sound effect software when the timing for playing a hint tone is matched.

15. The method as set forth in claim 13, wherein said mobile phone further comprises a voice module for converting a character or a sentence in said language learning content into a pronunciation that matches said language, and after the data with said language learning content input value is inputted into said mobile phone, further comprising the steps of: converting said data with said language learning content input value by said voice module into a format playable to said sound effect software; and saving all of said data into said database.
